(19) United States
(12) Patent Application Publication
(10) Pub. No.: US 2008/0134692 A1
(43) Pub. Date: Jun. 12, 2008

(54) Gas Transfer Hose

(75) Inventor: David Michael Crowley, Marl Buckinghamshire (GB)

Correspondence Address: CROWELL & MORING LLP;INTELLECTUAL PROPERTY GROUP, P.O. BOX 14300, WASHINGTON, DC, 20044-4300, US

(73) Assignee: Siemens Magnet Technology Ltd., Witney Oxfordshire, GB (GB)

(21) Appl. No.: 10/591,866

(22) PCT Filed: Mar. 4, 2005
(86) PCT No.: PCT/GB05/00856

§ 371 Date: Oct. 5, 2007

(30) Foreign Application Priority Data
Mar. 6, 2004 (GB) 0405096.9

(51) Int. Cl. F17C 13/00; F16L 9/18

(52) U.S. Cl. 62/50.7; 138/114

(57) ABSTRACT

A gas transfer hose for connecting a cryogenic apparatus to a superconducting system such as a magnetic resonant imaging system. The improved gas transfer hose, in operation, is quieter than hitherto.

### FIELD OF THE INVENTION

The present invention relates to cryogenic assemblies for magnetic resonant imaging systems and the like. In particular, but not necessarily restricted thereto, the present invention relates to a cryogenic hose of the type which is employed to connect a cryogenic compression apparatus to a superconducting system such as a magnetic resonant imaging system.

### BACKGROUND TO THE INVENTION

In many cryogenic applications components, e.g. superconducting coils for magnetic resonance imaging (MRI), superconducting transformers, generators, electronics, are cooled by keeping them in contact with a volume of liquefied gas (e.g. Helium, Neon, Nitrogen, Argon, Methane), the whole cryogenic assembly being known as a cryostat. In order to operate a superconducting magnet, it must be kept at a temperature below its superconducting transition temperature. For conventional low temperature superconductors, the transition temperature is in the region of 10K, and typically the magnet is cooled in a container or vessel comprising a bath of liquid helium, commonly called a helium vessel, at 4.2K. For simplicity, reference shall now be made to helium, but this does not preclude the use of other gases. Services need to be run from the external environment at room temperature into the helium vessel, for monitoring purposes and to energize the magnet.

The cooling, liquefaction and/or further cooling of gasses such as helium require the generation of very low temperature refrigeration. Helium liquefies at 4.21K. The generation of such a low temperature is very expensive and any improvements in cost and efficiency are very desirable. Pulse tube refrigerators are being increasingly used wherein pulse energy is converted to refrigeration using an oscillating gas. Such systems can generate refrigeration to very low levels, sufficient to liquefy helium. Gifford McMahon (GM) coolers are also used in such applications.

It will be appreciated that cryostats are not closed systems and have access necks to enable gas replenishment, service of the pulse tube refrigerator sleeve etc. Furthermore the pulse tube system relies upon a supply of oscillating gas driven by a compressor system. As will be appreciated, the pulse tube system has input and output tubes between the compressor and the cryostat. Equally GM coolers have such input and output tubes. These pairs of gas transfer hoses conduct refrigerant gases from a compressor source to a cooling device within a cryostat. These hoses are constructed from convoluted hose to withstand the pressures. As the gas passes over the internal convolutions a whistling sound is created. This is typically most dominant in the low pressure hose, where the gas is more voluminous having expanded, as its energy and temperature have been increased during the energy transfer process of cooling in the cryostat.

This whistling noise is, at the minimum annoying for operatives of a cryostat, but can have untoward effects for patients in a magnetic resonant imaging system. It should be remembered that many magnetic resonant systems closely surround patients and this may make a patient fearful—if a patient is uncomfortable or disturbed during an imaging scan, then they may physically move the part of their body being scanned resulting in a failure of the scanning operation. Furthermore, the acoustic disturbance can set up vibrational disturbances in the associated equipment. The cooling device's performance may be limited due to flow disturbance. The scanning device and other equipment operable to scan a patient/subject may also work less well with tolerances being larger than preferred.

### OBJECT OF THE INVENTION

The present invention seeks to provide an improved cryogenic assembly. The present invention also seeks to reduce the sound levels produced by a cryogenic apparatus and the level of noise transferred through a gas transfer hose.

### STATEMENT OF THE INVENTION

The present invention accordingly provides apparatus and a method as defined in the appended claims.

In accordance with an aspect of the invention, there is provided a gas transfer hose for supplying a compressed gas to an equipment, and conducting a return flow of gas from the equipment. The hose comprises a inner and outer coaxial hoses defining a first inner conduit and a second circumferential conduit which surrounds the first conduit. One conduit is operable to transfer the compressed gas from a compressor to the equipment and the other conduit is operable to transfer the return flow of gas from the equipment to the compressor.

The inner hose may be supported within the outer hose by supports. At least one of the inner and outer hoses may be convoluted. An inner or an outer surface of at least one of the inner and outer hoses is covered in braiding. The hoses may be formed from stainless steel.

The present invention also provides a cryogenic assembly comprising a compressor and a refrigerator each having respective gas inlet and outlet ports joined by a gas transfer hose of the present invention. The first, inner conduit may be arranged to conduct the return flow of gas from the refrigerator.

The present invention also provides MRI equipment comprising a cryogenic assembly according to the present invention.

The present invention also provides a method of operating a cryogenic assembly comprising a cryostat, a compressor and a gas transfer hose, wherein the hose comprises a first axial conduit and a second circumferential conduit which surrounds the first conduit, the method steps comprising passing high pressure gases from a compressor to a cryostat through one conduit and passing low pressure, high velocity from the cryostat to the compressor.

### BRIEF DESCRIPTION OF THE FIGURES

The invention may be understood more readily, and various other aspects and features of the invention may become apparent from consideration of the following description and the figures as shown in the accompanying drawings, wherein:

FIG. 1 shows a prior art cryostat-compressor arrangement;

FIG. 2 shows cross-sectional view of an embodiment of the invention;

FIG. 3 shows a cryostat-compressor arrangement in accordance with the invention; and

FIG. 4 shows a hose according to the present invention in more detail.

### DETAILED DESCRIPTION OF THE INVENTION

There will now be described, by way of example, the best mode contemplated by the inventors for carrying out the invention. In the following description, numerous specific details are set out in order to provide a complete understanding of the present invention. It will be apparent, however, to those skilled in the art, that the present invention may be put into practice with variations of this specific.

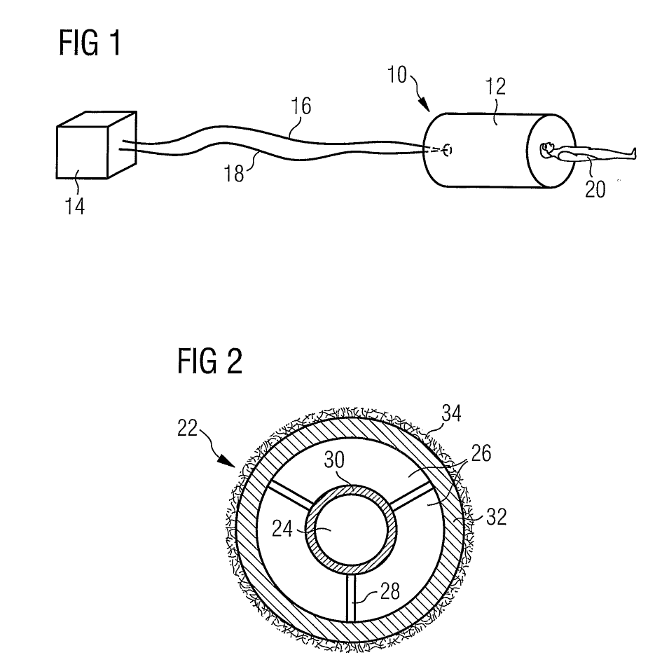

FIG. 1 shows a basic representation of a magnetic resonant imaging machine system 10 with a cryostat and imaging equipment 12 enclosing a patient 20. Gas transfer hoses 16 and 18 connect the compressor 14 with the equipment 12. An pulsed supply of gas flows from the compressor 14 to a refrigerator, cryostat, or other equipment 12, and back again from the refrigerator, cryostat, or other equipment 12 to the compressor. The present invention is particularly applicable to supply and return hoses used to supply a refrigerator 12 with pulsed or oscillating gas flow from a remote compressor 14.

The hoses 16, 18 are preferably convoluted, so as to better withstand the required operating pressures. The hoses 16, 18 may be formed from thin walled stainless steel. As the gas passes over the internal convolutions of each hose, a whistling sound is created. This is typically most dominant in the low pressure hose, where the gas is more voluminous having expanded, as its energy and temperature have been increased during the energy transfer process of cooling in the cryostat. The volume flow rate in the low pressure hose is accordingly significantly greater than the volume flow rate in the high pressure hose. Such acoustic disturbances may set up vibrational disturbances in the equipment 12. This may limit the ability for the equipment 12 to be usefully employed in industrial and medical applications which may be intolerant of physical vibrations. The noise itself can limit the use of equipment 12 using such gas hoses due to the unpleasant working environment for the operator caused by the noise. In medical applications, the noise may cause an unpleasant environment for the patient, which may be stressful and may cause the patient to move, preventing clear imaging.

FIG. 2 shows a cross-sectional view through a gas transfer hose 22 made in accordance with an embodiment of the invention. An inner hose 30 defines an inner conduit 24 within a second conduit 26 defined by outer hose 32. Braiding 34 preferably surrounds the hose 32 for strength and abrasion resistance. Inner hose 30 is supported within the outer hose 32 by supports 28 which may be continuous supports—for example as made in an extrusion process—or may be individual supports placed at regular intervals. It is important, in the event that individual supports are employed, that the supports are spaced such that they do not allow the inner hose to lie against the outer hose.

As with the prior art arrangement of FIG. 1, the hoses 30, 32 are preferably convoluted, so as to better withstand the required operating pressures. The hoses 30, 32 may be formed from thin walled stainless steel. As the gas passes over the internal convolutions of each hose, a whistling sound is created. This is typically most dominant in the low pressure hose, where the gas is more voluminous having expanded, as its energy and temperature have been increased during the energy transfer process of cooling in the cryostat. The volume flow rate in the low pressure hose is accordingly significantly greater than the volume flow rate in the high pressure hose.

The inventors have found that the coaxial arrangement of hoses as shown in FIG. 2 contributes to an overall reduction in the level of noise produced in the hoses. It is believed that noise generated by gas flowing through one conduit is cancelled, to some extent, by noise due to gas which is flowing in the opposite direction in the other conduit.

Once a piece of equipment 12 is installed and the minimum distance between compressor 14 and equipment 12 such as a cryostat is determined, the length of the hose 22 can be tuned to achieve a minimum noise level. Conveniently, in use, the supply of compressed gas is provided from the compressor 14 through the outer conduit 26. The return flow of low pressure gas from the supplied equipment 12 flows through the inner conduit 24. In such an arrangement, the second conduit 26 can further reduce noise transmission to a certain extent by a muffling effect. The functions of the outer and inner conduits may be reversed.

While braiding 34 is shown in the embodiment if FIG. 2 for strength and abrasion resistance, similar braiding may be applied to the outer surface of the inner hose 30. As well as increasing the overall strength of the structure, such a placement of braiding may also reduce noise still further, by damping the vibrations of the wall of inner hose 30. Such braiding may also advantageously streamline the flow of gas through the outer conduit 26.

In certain embodiments, the inner surfaces of hoses 30, 32 may also or alternatively be braided. Such braiding will not provide abrasion resistance, but may reduce the overall level of noise, either by mechanically damping vibration of the hoses, or by streamlining the gas flows through the conduits.

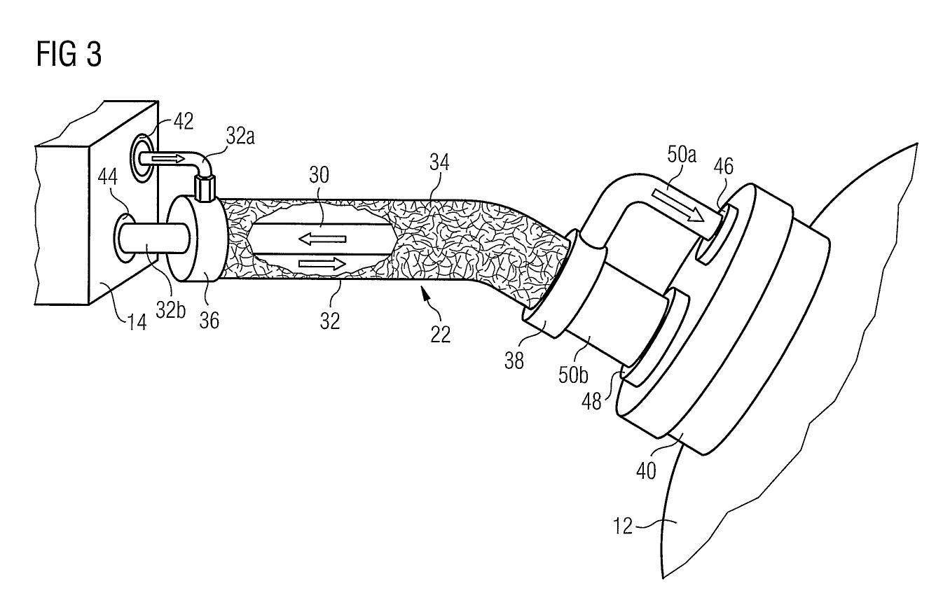

FIG. 3 shows a schematic, part sectional representation of a hose in accordance with the invention in operating position, linking a compressor 14 to a refrigerator, cryostat, or other supplied equipment 12. At the compressor 14, there is an outlet 42 and an inlet 44, providing connection to hose conduits 32a and 32b to supply compressed gases to the equipment 12; and to receive high velocity, low pressure exhaust gases from the equipment 12, respectively, via hose 30. At the equipment 12, there is an inlet 46 and an outlet 48 providing connection to hose conduits 50a and 50b, to receive compressed gases from the compressor 12; and to supply high velocity, low pressure exhaust gases to the compressor 12, respectively. Hose conduits 32a and 50a connect to flanges 36, 38 which are associated with the outer conduit 26 and compress outer tube 32 against a terminal/junction piece (not shown). Such junction piece preferably has rounded contours to enable a smooth gas flow between outer conduit 26 and respective hose conduits 32b and 50b. At the equipment 12 the tubes 50b and 50a connect with outlet 48 and inlet 46 ports. The ports 46, 48 maybe associated with a service neck 40 of a cryostat 12.

Inside tube 30 may carry low pressure gas, as this will generate most noise and can then be more effectively soundproofed by enclosure within the outer tube 32. Alternatively, the inner hose 30 may provide a conduit 24 for the compressed gas, where it is likely to suffer less energy increase from the exhausted gas at low pressure. The outer conduit 26 may have a larger cross-sectional area than inner conduit 24, making it more suitable for carrying the low pressure gas. By carrying the low pressure gas through the outer conduit and the high pressure gas through the inner conduit, the respective gas speeds may be made more equal, which may have a beneficial effect on noise cancellation.

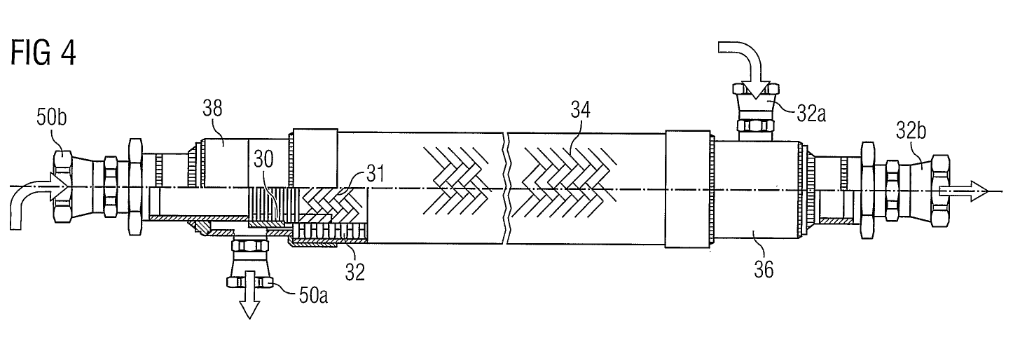

FIG. 4 shows an embodiment of the present invention in more detail. As shown, outer hose 32 is convoluted, and covered in braiding 34 on its outer surface. Similarly, inner hose 30 is convoluted and covered in braiding 31 on its outer surface. The remaining features carry labels corresponding to the labels of FIG. 3.

Comparative tests have been conducted using Siemens OR64 magnetic resonance system, connected to a Sumitomo model reference CSW 71 gas compressor. A microphone was mounted on a tripod 1.15 m above floor level, 0.46 m away from a magnet to detect noise emitted by the hoses. At various pulse tube refrigerator operating frequencies (1.56, 1.75, 1.8 Hz), the noise levels at five positions were tested.

In the reference arrangement, conventional twin hoses were used. A separate 35 mm diameter, 20 m long convoluted hose was used to connect each of the inlet 44 and outlet 42 ports of the compressor 14 to the corresponding port 46, 48 of the magnet. The results of this conventional arrangement were compared with an arrangement using a hose 22 according to the present invention with a bidirectional coaxial hose 22, again of 20 m length, having coaxial convoluted outer 32 and inner 30 hoses. The hose 22 had a first conduit 24 having an inside diameter of 25 mm and a second conduit 26 having an inside diameter of 50 mm. The coaxial inner hose 30 had an outside diameter of 35.1 mm.

The results showed that the arrangement according to the present invention produced a reduction in hose noise of up to 3 dB. Differences in heat exchange properties were also noticeable.

The present invention provides a neat solution to the issue of gas induced noise in gas conduit pipes supplied with pulse dor oscillating gas flow. In the setting up of a system it will be necessary to tune the length of a conduit to enable appropriate connection of services to a cryostat. A minimum length of hose can be used as a guide to the actual length of tube required. Once a reduced noise level has been attained with the cryostat in operation, it may be worthwhile employing sound insulating foam about the hose to still further reduce noise transmitted by the hose. While the invention has been described with particular reference to convoluted hoses, at least some of the advantages of the present invention may be achieved with non-convoluted hoses.

While the invention has been discussed with particular reference to gas supply to and from refrigerators for MRI systems, at least some of the advantages of the present invention may be achieved in any application where return supply of gas is required, particularly pulsed or oscillating supplies of gas.

1-11. (canceled)

12. A gas transfer hose providing supply and return paths for a pulsed oscillating gas flow for supplying a compressed gas to an equipment, and conducting a return flow of gas from the equipment, wherein the hose comprises an inner and outer coaxial hoses defining a first inner conduit and a second circumferential conduit which surrounds the first conduit, one conduit being operable to transfer the compressed gas from a compressor to the equipment and the other conduit being operable to transfer the return flow of gas from the equipment to the compressor.

13. A gas transfer hose according to claim 12, wherein the inner hose is supported within the outer hose by supports.

14. A gas transfer hose according to claim 12, wherein at least one of the inner and outer hoses is convoluted.

15. A gas transfer hose according to claim 12, wherein an outer surface of at least one of the inner and outer hoses is covered by braiding.

16. A gas transfer hose according to claim 12, wherein an inner surface of at least one of the inner and outer hoses is covered in braiding.

17. A gas transfer hose according to claim 12, wherein the inner and outer hoses are formed from stainless steel.

18. A cryogenic assembly comprising a compressor and a refrigerator each having respective gas inlet and outlet ports joined by a gas transfer hose according to claim 12.

19. A cryogenic assembly according to claim 18, wherein the first, inner conduit is arranged to conduct the return flow of gas from the refrigerator.

20. MRI equipment comprising a cryogenic assembly according to claim 18.

21. A method of operating a cryogenic assembly comprising a cryostat, a compressor and a gas transfer hose, wherein the hose comprises a first axial conduit and a second circumferential conduit which surrounds the first conduct, the method steps comprising the passing through one conduit high pressure gases from a compressor to a cryostat and passing low pressure, high velocity from the cryostat to the compressor.
